(19) United States
(12) Patent Application Publication
(10) Pub. No.: US 2025/0264280 A1
(43) Pub. Date: Aug. 21, 2025

(54) SAND-BASED THERMAL STORAGE APPARATUS

(71) Applicant: EVSAND INC., Dundas (CA)

(72) Inventor: Derrick WELSH, Dundas (CA)

(21) Appl. No.: 19/054,959

(22) Filed: Feb. 17, 2025

Related U.S. Application Data
(60) Provisional application No. 63/554,655, filed on Feb. 16, 2024.

(51) Int. Cl. F28D 20/00; F24H 3/06; F24H 3/12; F28D 20/02

(52) U.S. Cl. CPC F28D 20/0056; F24H 3/062; F24H 3/12; F28D 20/028; F28D 2020/0013; F28D 2020/0082

(57) ABSTRACT

A sand-based thermal storage apparatus, and a related system and method for heating a building are provided. The apparatus comprises an outer vessel, an inner vessel, a particulate heat storage material, and an electric heater. An annular interwall air space is defined between a wall of the outer vessel and a wall of the inner vessel, and surrounds the inner vessel. The interwall air space is in fluid communication with an outer vessel inlet and an outer vessel outlet. The particulate heat storage material comprises sand and is disposed in the inner vessel interior space and in contact with the inner vessel wall. At least part of the electric heater is embedded in the particulate heat storage material.

### CROSS-REFERENCE TO RELATED APPLICATION

The present application claims the benefit of and priority to U.S. Provisional Patent Application 63/554,655, filed Feb. 16, 2024, and titled “SAND-BASED THERMAL STORAGE APPARATUS”, the contents of which are incorporated herein by reference in their entirety.

### FIELD OF THE DISCLOSURE

The present disclosure relates to thermal storage apparatuses and related systems and methods for heating of buildings, and houses in particular.

### BACKGROUND OF THE DISCLOSURE

In North America, the most common type of home heating system is a forced air furnace system that burns a fossil fuel (e.g., natural gas) to heat air and circulates the heated air through ductwork. Environmental concerns are motivating use of electrically powered heating systems (e.g., electric heat pumps and electric radiant heaters), but this has its own drawbacks. In many markets, electricity is sold to homeowners based on fluctuating time of use (TOU) price rates, and demand charges that depend on the consumer's peak power consumption rates. Concerns also exist about the ability of electrical grids to meet electricity demands for home heating, such as during prolonged periods of severe cold weather.

### SUMMARY OF THE DISCLOSURE

It would be desirable for homeowners to be able to schedule electricity usage for heat generation in the most economical manner, and to store heat in the event of electricity supply failure. This requires a thermal storage apparatus to store generated heat and release the heat when desired. It would be preferable for such a heat storage apparatus to be economical, low maintenance, and conveniently retrofitted to ductwork of an existing forced air furnace system.

In one aspect, the present disclosure comprises an apparatus. The apparatus comprises an outer vessel, an inner vessel, a particulate heat storage material, and an electric heater. The outer vessel comprises an outer vessel wall that defines an outer vessel interior space, an outer vessel inlet, and an outer vessel outlet. The outer vessel inlet and the outer vessel outlet are spaced apart from each other in a longitudinal direction. The inner vessel extends in the longitudinal direction and comprises an inner vessel wall that defines an inner vessel interior space. The inner vessel is disposed in the outer vessel interior space with the inner vessel wall spaced apart from the outer vessel wall in a lateral direction transverse to the longitudinal direction to define an annular interwall air space. The interwall air space is between the outer vessel wall and the inner vessel wall, surrounds the inner vessel wall, and is in fluid communication with the outer vessel inlet and the outer vessel outlet. The particulate heat storage material comprises sand and is disposed in the inner vessel interior space and in contact with the inner vessel wall. At least part of the electric heater is embedded in the particulate heat storage material. Additional aspects of the apparatus are described herein.

In another aspect, the present disclosure comprises a system for heating a building. The building comprises a supply air duct terminating in a heat vent. The system further comprises an apparatus as described herein, wherein the outer vessel outlet is connected to the supply air duct to permit fluid communication from the interwall air space to the supply air duct via the outer vessel outlet. Additional aspects of the system are described herein.

In another aspect, the present disclosure comprises a method for heating a building. The method comprises supplying electrical energy to the electric heater of an apparatus as described herein to heat the particulate heat storage material; allowing the inner vessel wall to conduct heat from the particulate heat storage to the interwall air space; and operating a fan to flow air through the interwall air space from the outer vessel inlet to the outer vessel outlet. Additional aspects of the method are described herein.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 is an isometric view of an embodiment of a thermal storage apparatus of the present disclosure;

FIG. 2A a top view of the apparatus of FIG. 1;

FIG. 2B is an elevation view of the apparatus of FIG. 2;

FIG. 3A is an isometric view of an outer vessel of the apparatus of FIG. 1;

FIG. 3B is an isometric view of an inner vessel of the apparatus of FIG. 1;

FIG. 3C is an isometric view of an electric heater of the apparatus of FIG. 1;

FIG. 3D is an isometric view of a plenum of the apparatus of FIG. 1;

FIG. 4 is a functional block diagram of certain components of an embodiment of a thermal heating apparatus of the present disclosure;

FIG. 5 is a perspective view of a second embodiment of a thermal storage apparatus of the present disclosure;

FIG. 6 is a sectional elevation view of a third embodiment of a thermal storage apparatus of the present disclosure, with a schematic depiction of electrical components;

FIG. 7 is a sectional elevation view of a fourth embodiment of a thermal storage apparatus of the present disclosure, with a schematic depiction of electrical components; and

FIG. 8 is a flow chart of an embodiment of a method of operating a thermal storage apparatus of the present disclosure to heat a building and to regulate barometric pressure inside of the building.

### DETAILED DESCRIPTION OF EMBODIMENTS OF THE DISCLOSURE

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise explained, all technical and scientific terms used herein have the same meaning as commonly understood by one of ordinary skill in the art to which this disclosure belongs.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. It will be understood that any embodiments described as “comprising” certain components may also “consist of” or “consist essentially of” these components, wherein “consisting of” has a closed-ended or restrictive meaning and “consisting essentially of” means including the components specified but excluding other components except for components added for a purpose other than achieving the technical effects described herein.

It will be understood that any component defined herein as being included may be explicitly excluded from the claimed invention by way of proviso or negative limitation, such as any specific component or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.”

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

“Memory” refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile discs (DVDs), magnetic media such as floppy disks, magnetic tapes or cassettes, and solid state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such as way as to be accessible by a processor. Instructions stored by a memory may be based on a plurality of programming and/or markup languages known in the art, with non-limiting examples including the C, C++, C#, Python™, MATLAB™, Java™, JavaScript™, Perl™, PHP™, SQL™, Visual Basic™, Hypertext Markup Language (HTML), Extensible Markup Language (XML), and combinations of the foregoing. Instructions stored by a memory may also be implemented by configuration settings for a fixed-function device, gate array or programmable logic device.

“Processor” refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi processor architectures, microprocessors, microcontrollers, microcontroller units (MCU), central processing units (CPU), field-programmable gate arrays (FPGA), application specific circuits (ASIC), digital signal processors, programmable logic controllers (PLC), and combinations of the foregoing.

Any method, application or module herein described may be implemented using computer readable/executable instructions that may be stored or otherwise held by a memory, and executed by a processor. Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the inventions described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### Overview of Thermal Storage Apparatus

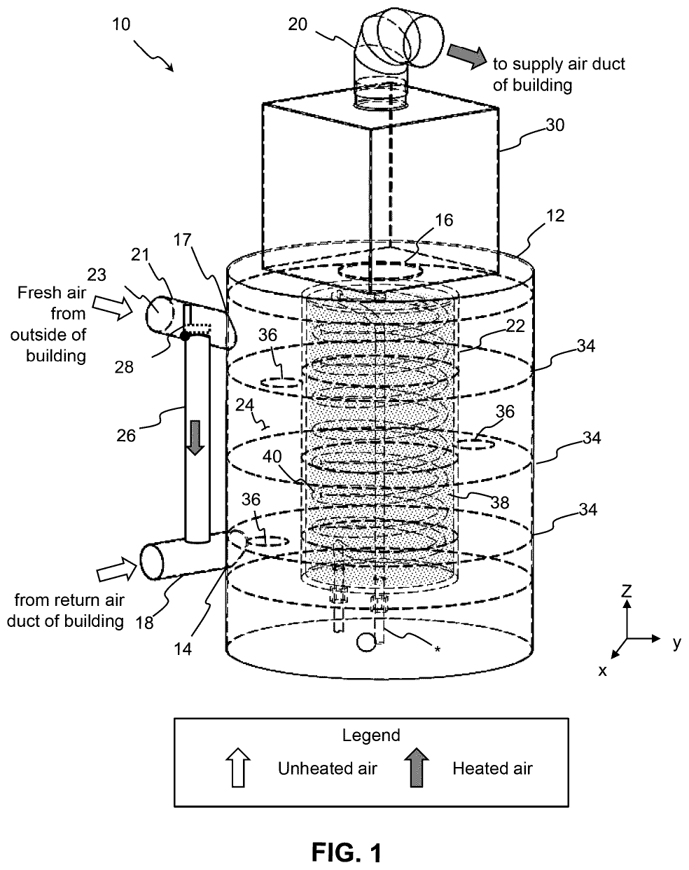

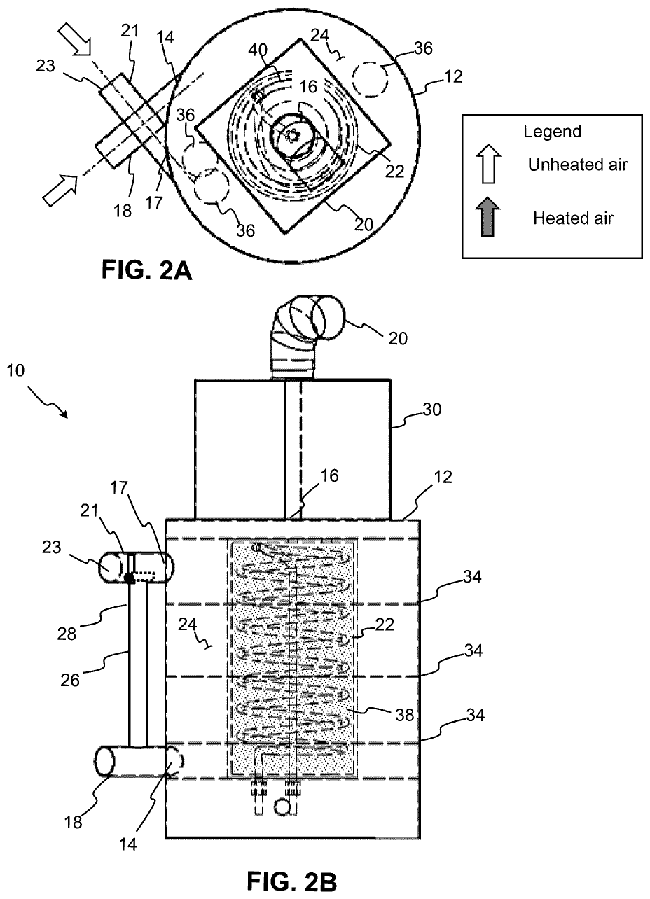

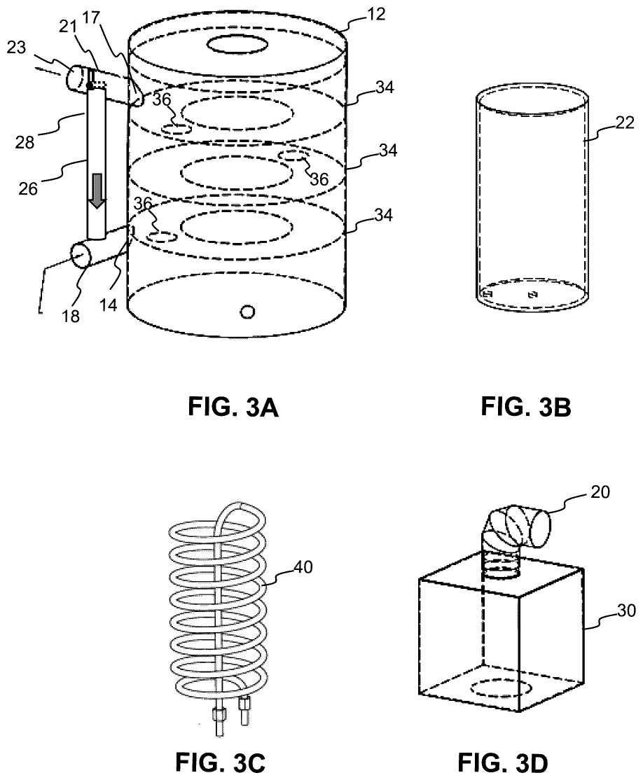

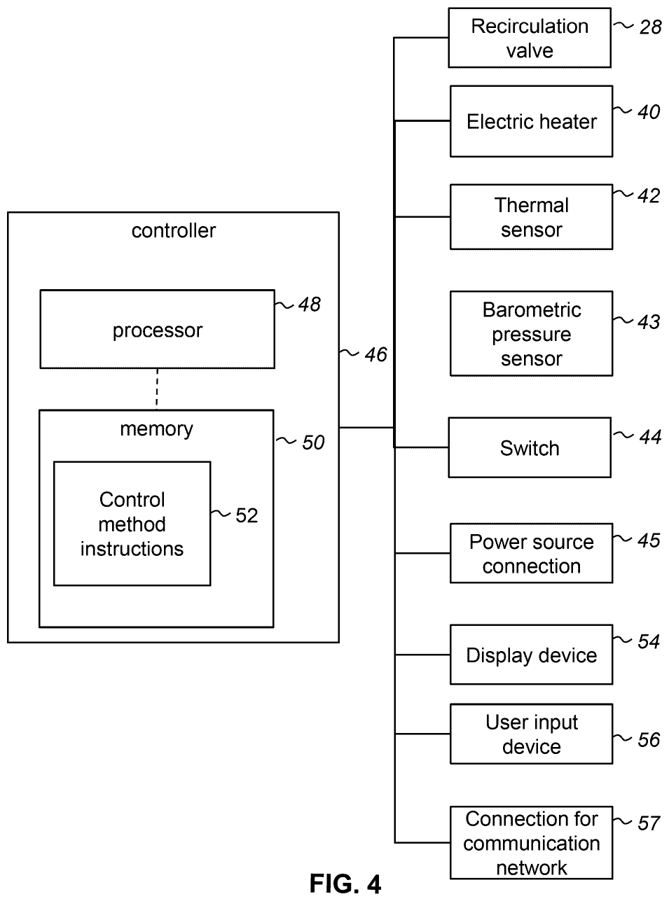

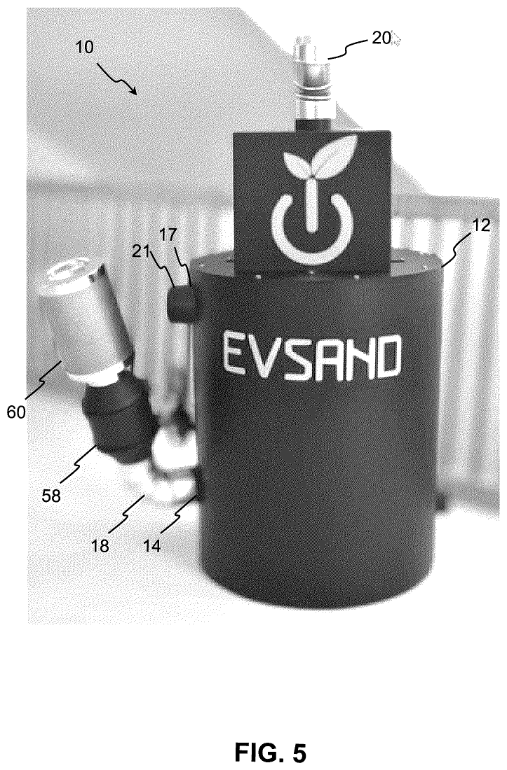

FIGS. 1 to 2B show a perspective view (FIG. 1), a top plan view (FIG. 2A) and a side elevation view (FIG. 2B) of an embodiment of a thermal storage apparatus 10 (hereinafter, simply, an “apparatus”). FIGS. 3A to 3D show components of the apparatus 10 of FIG. 1. FIG. 4 shows a functional block diagram of some components of the apparatus 10 with lines between the components indicating operative connections, which may be implemented by wired connections and wired connection protocols (e.g., USB, Ethernet, etc.) and/or wireless connection protocols (e.g., WiFi™, Bluetooth™, etc.) as known in the art. FIGS. 5, 6, and 7, show further embodiments of the apparatus 10.

For convenient discussion, FIG. 1 shows the apparatus 10 in relation to a set of orthogonal reference x-, y- and z-axes. In the following discussion, the longitudinal direction refers to the direction coinciding with the direction of the z-axis, which may be the substantially vertical direction. The lateral direction refers to the direction transverse to the longitudinal direction, such as the directions coinciding with the x-axis or the y-axis, which may be substantially horizontal directions. It will be understood that the terms longitudinal direction and transverse direction are used herein in a relative sense, and do not limit the apparatus 10 to a particular orientation.

In general, the apparatus 10 includes an outer vessel 12, an inner vessel 22, a particulate heat storage material 38, and an electric heater 40. These and other components of the apparatus 10 are described below.

### Outer Vessel, Inner Vessel, and Interwall Space

The outer vessel 12 is a structure that allows for through flow of air. The outer vessel 12 has an outer vessel wall that defines an outer vessel interior space. The outer vessel wall also defines an outer vessel inlet 14 that allows for flow of unheated air into the interwall air space 24 (as described below). The outer vessel wall also defines at least one outer vessel outlet 16 that allows for flow of heated air out of the interwall air space 24 (as described below). (It will be understood that the terms “unheated air” and “heated air” are used in a relative sense, and do not prescribe any particular temperature of the air). The outer vessel inlet 14 and the outer vessel outlet 16 are spaced apart from each other in the longitudinal direction (e.g., the vertical direction). In the embodiment of FIG. 1, the outer vessel outlet 16 is disposed above the outer vessel inlet 14, which may facilitate flow of heated air through the interwall air space 24 due to the tendency of heated air to rise within the outer vessel 12. In the embodiment shown in FIG. 1, the outer vessel inlet 14 is attached to an inlet conduit 18 which may be connected to a return air duct (not shown) of a building (e.g., a house). The outer vessel outlet 16 is attached via a plenum 30 to an outlet conduit 20 which may be connected to a supply air duct (not shown) of the building.

The inner vessel 22 is a structure that is used to contain the particulate heat storage material 38. The inner vessel 22 extends in the longitudinal direction. The inner vessel 22 has an inner vessel wall that defines an inner vessel interior space that is used to store the particulate heat storage material 38.

The inner vessel 22 is disposed in the outer vessel 12 interior space with the inner vessel wall spaced apart from the outer vessel wall in a lateral direction transverse to the longitudinal direction to define an annular interwall air space 24 between the outer vessel wall and the inner vessel wall. The interwall air space 24 surrounds the inner vessel wall and is in fluid communication with the outer vessel inlet 14 and the outer vessel outlet 16. “Annular” as used herein, refers to the interwall air space 24 having a ring-shape in a cross-sectional plane in the lateral direction, but the ring-shape need not be circular. For example, the inner vessel 22 and the outer vessel 12 may both have a non-circular shape (e.g., rectangular or other polygonal shape) in a cross-sectional plane in lateral direction so as to define non-circular (e.g. a rectilinear or other polygonal) ring-shaped interwall air space 24 that surrounds the inner vessel wall, which is considered to be within the meaning of the term “annular” as used herein.

The outer vessel wall and the inner vessel wall may be made of a variety of suitable materials. In one embodiment, the outer vessel wall may have a layer of a thermally insulative material. In embodiments, the insulative material may comprise a mineral wool material (e.g., Rockwool™; Rockwool International) or another inorganic insulation material (e.g., fiberglass wool). The thermally insulative material helps to reduce heat loss from the heated air in the interwall air space 24 through the outer vessel wall. In one embodiment, the inner vessel wall may be made of a metallic material, such as steel. The metallic material may be selected to have a relatively high thermal conductivity to facilitate conduction of heat from the particulate heat storage material on the inside of the inner vessel wall to the air in the interwall air space 24 on the outside of the inner vessel wall.

The outer vessel 12 and the inner vessel 22 may have a variety of different shapes in different embodiments. In the embodiment shown in FIG. 1, both the outer vessel wall and the inner wall vessel have a substantially cylindrical shape with a central axis extending in the longitudinal direction. In this embodiment, the central axes of the outer vessel 12 and the inner vessel 22 are collinear with each other so that the distance between the outer vessel wall and the inner vessel wall is substantially uniform in all lateral directions. In other embodiments, the outer vessel 12 and/or the inner vessel 22 may have other shapes such as an elliptical (oval) shape in a cross-sectional plane in the lateral direction, or an overall rectangular prismatic shape. In embodiments, the outer vessel 12 and the inner vessel 22 may have the same or similar shape (e.g., both are cylindrical in shape), or they may have different shapes (e.g., the outer vessel 12 is rectangular prismatic, and the inner vessel 22 is cylindrical). In embodiments, the outer vessel 12 may have a closeable opening (e.g., lidded opening) to access the inner vessel 22 disposed therein. In embodiments, the inner vessel 22 may have a closeable opening (e.g., a lidded opening) to allow for loading of the particulate heat storage material 38 therein at an installation site.

In embodiments, a proportion of a length of the inner vessel wall in the longitudinal direction to a distance between the outer vessel inlet 14 to the outer vessel outlet 16 in the longitudinal direction, expressed as a percentage, is at least 90 percent, 100 percent, or more. In the embodiment shown in FIG. 2B, for example, the inner vessel wall is adjacent to the outer vessel inlet 14 and the outer vessel outlet 16 in the lateral direction the length of the inner vessel wall is greater than the distance between the outer vessel inlet 14 and the outer vessel outlet 16. Accordingly, the air in the interwall air space 24 flows past the inner vessel wall along the entire path from the outer vessel inlet 14 to the outer vessel outlet 16.

Referring to FIG. 2, in this embodiment, the outer vessel inlet 14 is oriented to direct, into the interwall air space 24, an air stream that is offset from a center of the outer vessel 12 in a cross-sectional plane in the lateral direction. The outer vessel outlet 16 is oriented to direct, out of the interwall air space 24, an air stream that that is aligned with the longitudinal direction. As a result of this configuration, the air stream flows upwardly in a helical flow path, swirling circumferentially around the inner vessel 22 as the air stream flows from the outer vessel inlet 14 toward the outer vessel outlet 16.

Referring to FIG. 1, in this embodiment, the outer vessel 12 has an outer vessel outlet 16, and an outer vessel auxiliary opening 17. The outer vessel auxiliary opening 17 may act as a second outer vessel outlet or a fresh air intake, depending on the configuration of the recirculation valve 28, as described below. Thus, the first outer vessel outlet 16 is oriented to direct, out of the interwall air space 24, a first air stream in the longitudinal direction into a plenum 30 as described below. When the auxiliary outlet 17 is used as a second outer vessel outlet, the auxiliary outlet 17 is oriented to direct, out of the interwall air space 24, a second air stream in the lateral direction and which may be offset from a center of the outer vessel 12, which is then directed by the recirculation valve 28 to the recirculation conduit 26.

### Auxiliary Conduit, Recirculation Conduit and Valve

In the embodiment shown in FIG. 1, the apparatus 10 comprises an auxiliary conduit 21 that provides fluid communication between the outer vessel auxiliary opening 17 and an auxiliary inlet 23 of the auxiliary conduit 21. A recirculation conduit 26 branches from the auxiliary conduit 21 and permits fluid communication from the outer vessel auxiliary opening 17 to the outer vessel inlet 14. A recirculation valve 28 (which may be generally referred to as a valve) is positioned to regulate air flow through the auxiliary conduit 21 either to the recirculation conduit 26 or from the auxiliary inlet 23. In FIG. 1, the recirculation valve 28 is shown symbolically by a hinged flapper valve member but may be implemented by a variety of different valve types. When the flapper valve member is in the raised open position (shown in solid line), the recirculation valve 28 permits heated air exiting the outer vessel auxiliary opening 17 to flow through the recirculation conduit 26 and into the interwall air space via the outer wall inlet 14. When the recirculation valve 28 is in this configuration, the outer vessel auxiliary opening 17 may be considered to be a “second outer vessel outlet”. By opening the recirculation conduit 26, the heated air is allowed to flow from the outer vessel auxiliary opening 17 to the outer vessel inlet 14, and thereby preheat the unheated air before it enters the interwall air space 24. This may result in air exiting the outer vessel outlet 16 being at a higher temperature than if the air entering the interwall air space 24 were not preheated in this manner.

Conversely, when the flapper valve member is in the lower closed position (shown in dashed line), the recirculation valve 28 prevents air from entering the recirculation conduit 26. Instead, the recirculation valve 28 allows fresh air entering from the auxiliary inlet 23 to flow through auxiliary conduit 21 and the outer wall auxiliary opening 17 so that it can mix with heated air in the interwall air space 24 and the plenum 30 (as described below). For example, the auxiliary inlet 23 may be an inlet that is disposed outside of a house (e.g., on an exterior wall or a roof of a house) to allow for entry of fresh air.

In embodiments, the recirculation valve 28 is an electromechanically operated valve. The controller 46 (as described below) may activate the recirculation valve 28 based on a temperature measured by a thermal sensor 42 (as described below) and/or a pressure measurement by a barometric pressure sensor 43 (as described below). As a non-limiting example, the temperature measured by the thermal sensor 42 may be the temperature of air in a conduit upstream of the outer vessel inlet 14, and the controller 46 may actuate the recirculation valve 28 to open the recirculation conduit 26 when the measured temperature is below a threshold temperature.

As another non-limiting example, the barometric pressure measured by the barometric pressure sensor 43 may be the pressure of air in the plenum 30 or another location of a building (e.g., a house). The controller 46 may actuate the recirculation valve 28 to close the recirculation conduit 26 to allow fresh air from the auxiliary inlet 32 to enter via the interwall air space 24 into the plenum 30 to increase the barometric pressure in the house when the measured barometric pressure is below a predefined threshold pressure. This may be useful for rebalancing pressure inside a well-sealed house that would not otherwise permit entry of sufficient make-up air to compensate for depressurization effects of ventilation devices (e.g., a bathroom fan, range hood, or dryer vent) or fuel-burning appliances (e.g., a natural gas furnace).

### Plenum

In the embodiment shown in FIG. 1, the apparatus 10 comprises a plenum 30 extending from the outer vessel outlet 16 to a plenum 30 outlet to establish fluid communication from the interwall air space 24 to the outlet duct. The plenum 30 allows cooler fresh air from the auxiliary inlet 23 to mix with heated air from the interwall air space 24 before the heated air is further distributed via outlet conduit 20. A fan may be provided to draw a mixture of fresh air from auxiliary inlet and heated air from the interwall air space 24 into the plenum and through the outlet duct 20.

### Baffles in Interwall Air Space

In embodiments, the apparatus 10 further comprises at least one baffle 34 disposed in the interwall air space 24, and attached to at least one of the outer vessel wall and the inner vessel wall. The baffles 34 may be used to direct flow of air through the interwall air space 24 in a circuitous manner and/or slow the flow of air through the interwall air space 24 so that the air is sufficiently heated by heat that is conducted from the particulate heat storage material 38 via the inner vessel wall. In the embodiment shown in FIG. 1, the apparatus 10 has a plurality of baffles 34 that are spaced apart from each other in the longitudinal direction. Each of the baffles 34 is in the form of an annular baffle plate. The outer perimeter of the annular baffle plate is attached to the outer vessel wall. The annular baffle plate extends inwardly toward the inner vessel 22 so that there is no gap or only a small gap therebetween. Each baffle plate defines a baffle aperture 36 that allows fluid communication through the interwall air space 24 from the outer vessel inlet 14 to the outer vessel outlet 16. The baffle apertures 36 of adjacent baffle plates are spaced apart from each other in the lateral direction. For example, as shown in FIG. 1, adjacent baffle plates are rotated about a vertical axis with respect to each other by about 180 degrees so that their baffle apertures 36 are disposed on opposite sides of the inner vessel 22. As a result of this configuration, the baffles 34 direct air flowing through interwall air space 24 from the outer vessel inlet 14 to the outer vessel outlet 16 in a helical-like path.

### Particulate Heat Storage Material

The particulate heat storage material 38 is used to store the heat generated by the electric heater 40. The particulate heat storage material 38 comprises sand. “Sand” as used herein refers to granular mineral particles having a diameter less than about 5 mm. As non-limiting example, sand may comprise have mineral particles with a diameter in the range of about 0.0625 mm to about 4.75 mm. The present disclosure is not limited by any particular mineral composition of the sand, with a non-limiting example including a mixture of silicon dioxide (quartz) and feldspars (e.g., sodium feldspar and/or potassium feldspar).

In some embodiments, the particulate heat storage material 38 may consist of sand, to the exclusion of other materials. In some embodiments, the particulate heat storage material 38 may comprise sand intermixed with other material(s). As a non-limiting example, the other material may comprise metallic particles (e.g., steel particles).

The present disclosure is not limited by a particular bulk density of sand. In some embodiments, the sand may be packed or compressed within the inner vessel 22 to a bulk density of at least 1500 kg/m3, more particular at least 1600 kg/m3, or even more particularly about 1650 kg/m3. Increasing the bulk density of the sand may increase the energy density of the sand, thus allowing for storage of greater heat energy for a given volume of sand.

The mass of the particulate heat storage material 38 may be selected depending on factors such as its heat capacity, and the amount of heat energy to be stored. The latter factor will depend on factors such as the size of the space to be heated by the apparatus, and the temperature differential between the expected temperature of the unheated air and the desired temperature of the heated air. In one embodiment, the mass of sand contained in the inner vessel 22 is about 150 kg, 180 kg, or 200 kg. For example, heating 180 kg of sand with a specific heat capacity of about 800/(kg K) by about 600° C. will result in the sand storing about 87×10\hat{ }6 J of heat energy.

### Electric Heater

The electric heater 40 is a device that converts electrical energy to heat. In one embodiment, the electric heater 40 comprises a the resistive heating element 40 that generates heat by passage of electric current therethrough by the phenomenon of the Joule heating effect. In other embodiments, the electric heater 40 may convert electrical energy to heat in accordance with other principles of operation. At least part of the electric heater 40 is embedded in the particulate heat storage material 38. In other words, the electric heater 40 is at least partially, and possibly fully, buried in the particulate heat storage material 38, and in direct contact with the particulate heat storage material 38, so that heat generated by the electric heater 40 conducts to the particulate heat storage material 38. In embodiments, the electric heater 40 may have a variety of sizes and shapes (e.g., a wire or tube, a ribbon, a coil). In the embodiment shown in FIG. 1, the electric heater 40 has a coil shape with a central axis that extends in the longitudinal direction so as to permit relatively even heating of the particulate heat storage material 38 contained in the cylindrical inner vessel 22. The power density (i.e., heat flux per heated surface area) of the electric heater 40 may be selected to suit a particular application. In one embodiment, the power density of the electric heater 40 is sufficient so that it is operable to heat the particulate heat storage material 38 by at least about 800° C., or at least about 1000° C.

### Thermal Sensor

Referring to FIG. 4, in embodiments, the apparatus 10 may comprise a thermal sensor 42 to measure a temperature of a part of the apparatus 10. The thermal sensor 42 may be implemented by a variety of known technologies for thermal sensors. A thermocouple, a thermistor, a resistance temperature detector (RTD) or a semi-conductor based thermal sensor are non-limiting examples of thermal sensors that may be suitable depending on the installation location of the thermal sensor 42 and the temperatures to which the thermal sensor 42 is exposed. In one embodiment, a first thermal sensor 42 in the form of a thermocouple may be positioned in the inner vessel 22 interior space to measure a temperature at or near a center of the mass of the particulate heat storage material 38. A second thermal sensor 42 in the form of a thermocouple may be attached to the inner vessel wall to measure a temperature at or near the perimeter of the mass of the particulate heat storage material 38. In addition or in the alternative, one or more thermal sensors 42 may be provided to measure temperatures at other locations inside or outside of a building (e.g., a house). These temperature measurements may be used by the controller 46 (as described below) to regulate the supply of electrical power to the electric heater 40.

### Barometric Pressure Sensor

Referring to FIG. 4, in embodiments, the apparatus 10 may comprise a barometric pressure sensor 43 to measure a temperature of a part of the apparatus 10. The barometric pressure sensor 43 may be implemented by a variety of known technologies for barometric pressure sensors. A microelectromechanical (MEMS)-based barometer, or a silicon-based piezoresistive pressure-sensing barometer that generates electronic signals depending on barometric pressure are non-limiting examples of barometric pressure sensors that may be suitable. As a non-limiting example, a barometric pressure sensor 43 may be installed within the plenum 30, or at some location of a house that is situated remotely from the apparatus 10. The barometric pressure measurements generated by one or more barometric pressure sensors 43 may be used by the controller 46 (as described below) to control the recirculation valve 28, and/or used by the controller 46 (as described below) to control a switch 44 to regulate the supply of electrical power to the electric heater 40.

### Switch

Referring to FIG. 4, in embodiments, the apparatus 10 may comprise a switch 44 (e.g. a relay switch) that is operable to regulate supply of electrical power from the power source connection 45 (e.g., the electrical circuit of a house) to the electric heater 40. The controller 46 (as described below) may activate the switch 44 based at least on the temperature measured by the thermal sensor 42. For example, the processor 48 of the controller 46 may control the switch 44 to supply or increase supply of electrical power to the electric heater 40 when the temperature measured by the thermal sensor 42 is at or below a lower threshold temperature. As another example, the processor 48 of the controller 46 may control the switch 44 to interrupt supply or decrease supply of electrical power to the electric heater 40 when the temperature measured by the thermal sensor 42 is at or above an upper threshold temperature.

The activation of the switch 44 by the controller 46 may based on factors that are additional or alternative to the temperature measured by the temperature sensor 42. For example, the controller 46 may control the switch 44 based on the time of day. The controller 46 may comprise or be operatively connected to a computer clock. The controller 46 may control the switch 44 to control supply of electrical power to the electric heater 40 in accordance with predefined rules stored in the memory 50, that are based on the time of day. For example, the controller 46 may control the switch 44 to supply electrical power to the electric heater 40 only during predefined times corresponding to off-peak hours (e.g., between 12 a.m. to 3 p.m., and from 10 p.m. to 12 a.m.) associated with lower time-of use electricity rates. Alternatively, the controller 46 may control the switch 44 to supply electrical power to the electric heater 40 during such off-peak hours in preference to peak hours associated with higher time-of-use electricity rates.

As another example, the controller 46 may control the switch 44 based on a prevailing electricity price rate. A predefined schedule of electricity price rates during a day may be stored in the memory 50 of the controller 46. Alternatively, the controller 46 may be operatively connected to the internet or another communication network that allows the controller 46 to receive real-time time-of-use electricity price rates from a data source (e.g. a utility provider or regulator). The controller 46 may control the switch 44 to control supply of electrical power to the electric heater 40 in accordance with predefined rules stored in the memory 50, that are based on the electricity price rate. For example, the controller 46 may control activation of the switch 44 to interrupt or decrease supply electrical power to the electrical heater 40 if the prevailing electricity price rate is at or above an upper threshold price. Conversely, the controller 46 may control activation of the switch 44 to supply or increase supply of electrical power to the electrical heater 40 if the prevailing electricity price rate is at or below a lower threshold price. In other words, the controller 46 may control the switch 44 to supply electrical power to the electric heater 40 during periods with lower electricity price rates in preference to periods with higher electricity price rates.

As another example, the controller 46 may control the switch 44 in accordance with a calculated amount of heat required over a time period, in excess of heat that is stored by the particulate heat storage material 38. A first temperature sensor 42 may measure a first temperature at or near a center of the mass of the particulate heat storage material 38. A second temperature sensor 42 may measure a second temperature outside of the house. The controller 46 may calculate a required amount of electrical energy that needs to be input to the electrical heater 40 to maintain a house at a predefined temperature or temperature range (e.g., at about 20° C.) over a time period. This calculation may be based on a predefined relationship (e.g., a mathematical function, or a lookup table) stored in the memory 50, between the predefined temperature, the first temperature measurement and the second temperature measurement. The controller 46 may activate the switch 44 to control the supply of electrical power to the electric heater 40 based on the required amount of electrical energy. This may advantageously reduce the amount of electrical energy consumption, in comparison to a control algorithm that does not account for the amount of heat already stored by the particulate heat storage material 38. In embodiments, the control of the switch 44 may also be based on aforementioned predefined rules based on the time of day and/or electricity price rates. For example, the controller 46 may implement an algorithm stored in the memory 50 to determine a schedule for activating the switch 44 to supply electrical energy to the electric heater 40 to maintain the temperature of the particulate heat storage material 38 to meet the required amount of heat over the time period. Optionally, the algorithm may use the time of day and/or electricity price rates as a constraint or constraint(s) on the schedule, or factors for optimizing the schedule to minimize the cost to supply electricity to the electric heater 40 over the time period. For example, the time period selected for calculating the required amount of heat may include both off-peak hours (associated with relatively low electricity pricing rates) and peak hours (associated with relatively high electricity pricing rates). If the heat already stored by the particulate heat storage material 38 (as indicated by the temperature of the particulate heat storage material 38) is sufficient to satisfy the required amount of heat during the peak hours without supplying electrical energy to the electric heater 40 during the peak hours, then the controller 46 may determine a schedule that limits activating the switch 44, if necessary, to supply electrical energy to the electric heater 40 to off-peak hours that precede or follow the peak hours. If the heat already stored by the particulate heat storage material 38 is insufficient to satisfy the required amount of heat during the peak hours, then the controller 46 may determine a schedule that activates the switch 44 to supply electrical energy to the electric heater 40 during peak hours (and possibly during off-peak hours), but limits the amount of electrical energy supplied during the peak hours to a minimum amount needed to meet the required amount of heat during the peak hours.

### Controller

Referring to FIG. 4, in embodiments, the apparatus 10 may comprise a controller 46. The controller 46 includes at least one processor 48 and at least one memory 50. The memory 50 is a non-transitory computer readable medium that stores control method instructions 52 that are executable by the processor 48 to control an operatively connected electromechanical recirculation valve 28 and/or the switch 44, as discussed above, and/or a fan 58 as discussed below. The memory 50 storing the control method instructions 52 may be considered to be a computer-program product of the present disclosure.

FIG. 4 shows the processor 48 and the memory 50 by single functional blocks, but it will be understood that the processor 48 and the memory 50 may include a plurality of components or sub-components that are operatively connected to each other. For example, each of the processor 48 and the memory 50 may include a plurality of components that are physically discrete and remote from each other, but operatively connected together (e.g., by wire or wireless connections, and/or a communications network or protocols such as Wi-Fi, intranet or Internet protocols) in accordance with distributed computing techniques known in the art. For example, part of the processor 48 and memory 50 may be implemented by a microcontroller board programmed with firmware and forming part of a control panel, which is operatively connected to the thermal sensor 42, the barometric pressure sensor 43, the electromechanical recirculation valve 28, the switch 44, and/or the fan 58. Another part of the processor 48 and memory 50 may be implemented by a personal computer device (e.g., a smartphone, a tablet computer, a desktop computer, or a laptop computer) running a software application that interfaces wirelessly with the microcontroller board.

The controller 46 may be operatively connected to a display device 54 (e.g., a display screen of the personal computing device) for displaying information relating to the control and operation of the controller 46 and the control methods implemented by the controller 46. The processor 48 and memory 50 may also be operatively connected to a user input device 56 (e.g., a touch-sensitive display screen, a computer mouse, and/or a computer keyboard) for a user to provide information (e.g., threshold temperature values, threshold barometric pressure values, times of day corresponding to peak hours and off-peak hours of electricity price rates, and electricity price rates) relating to the control and operation of the controller 46 and the control methods implemented by the controller 46. The processor 48 and memory 50 may also be operatively connected to a connection for a communication network 57 (e.g., a modem) to receive some or all of such information.

### Second Embodiment With Fan and Filter

FIG. 5 shows an embodiment of the apparatus 10 similar to that shown in FIG. 1. In this embodiment, the apparatus 10 further comprises an electrically powered fan 58 disposed externally of the outer vessel 12 on an inlet conduit 18 connected to the outer vessel inlet 14. The fan 58 is operable to create an air flow from the outer vessel inlet 14 to the outer vessel outlet 16 via the interwall air space 24. In this embodiment, the apparatus 10 also comprises a filter 60 positioned to filter air upstream of the outer vessel inlet 14, by virtue of also being connected to the inlet conduit 18, upstream of the fan 58. The controller 46 (as described above) may activate the fan 58 based at least on the temperature measured by the thermal sensor 42 (as described above) or another thermal sensor. For example, in order to circulate air through the interwall air space 24 to heat a building, the processor 48 may activate the fan 58 when the temperature measured by the thermal sensor 42 is below or above a threshold temperature.

### Third Embodiment With Tube Connecting Outer Vessel Inlet 14 and Outlet

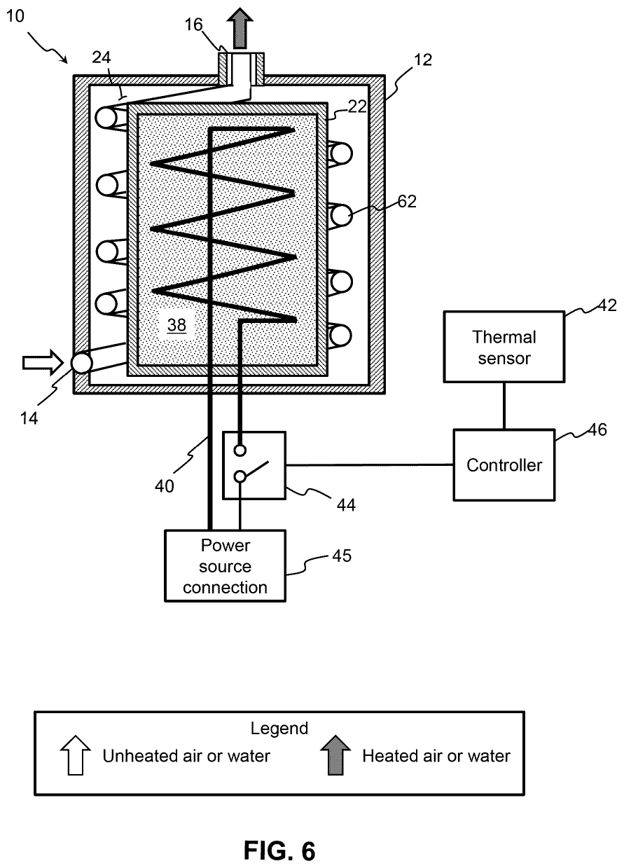

FIG. 6 shows an embodiment of the apparatus 10 similar to that shown in FIG. 1. In this embodiment, the apparatus 10 comprises a tube 62 extending from the outer vessel inlet 14, via the interwall air space 24, to the outer vessel outlet 16, to permit fluid communication from the outer vessel inlet 14 to the outer vessel outlet 16 via the tube 62. In this embodiment, the tube 62 has a coil shape wrapping around the inner vessel 22, but in other embodiments, may have different configurations (e.g., a straight tube). The tube 62 may be used to convey air or a liquid, thus extending the use of the apparatus 10 to heat a liquid. For example, the tube 62 may be used to circulate heated water to a home water tank to substitute or supplement the heat generated by a burner of the home water tank, or to a water-based radiant heating system to substitute or supplement the heat generated by a boiler of the radiant heating system.

### Fourth Embodiment With Tube Passing Through Particulate Heat Storage Material

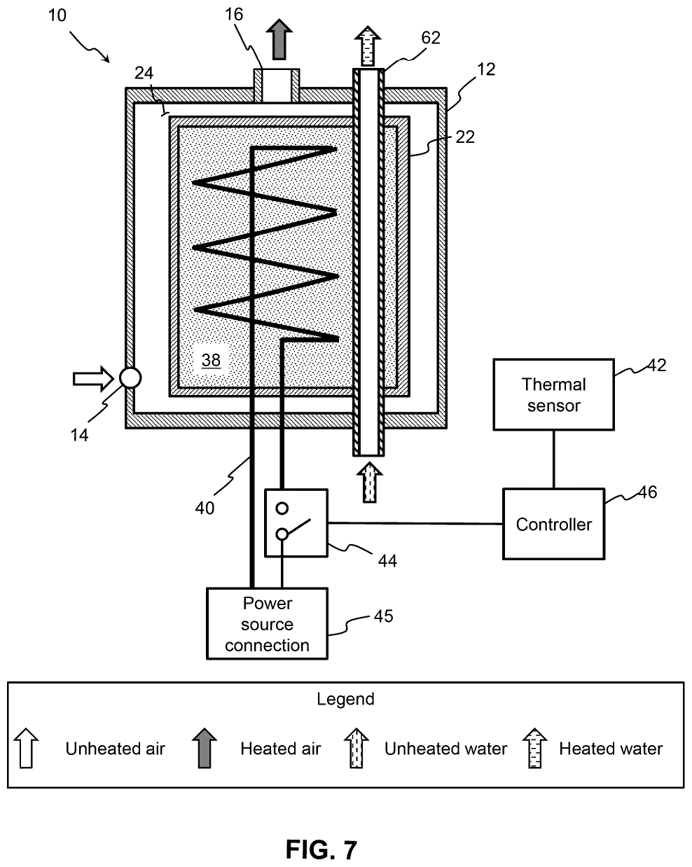

FIG. 7 shows an embodiment of the apparatus 10 similar to that shown in FIG. 1. In this embodiment, the apparatus 10 comprises a tube 62 extending through the outer vessel wall, the inner vessel wall and the particulate heat storage material 38. In this embodiment, the tube 62 is straight, but in other embodiments, may have different configurations (e.g., a coil shape with a vertically oriented central axis). Like the embodiment shown in FIG. 6, the tube 62 may be used to convey air or a liquid, thus extending the use of the apparatus 10 to heat a liquid.

### Use and Operation

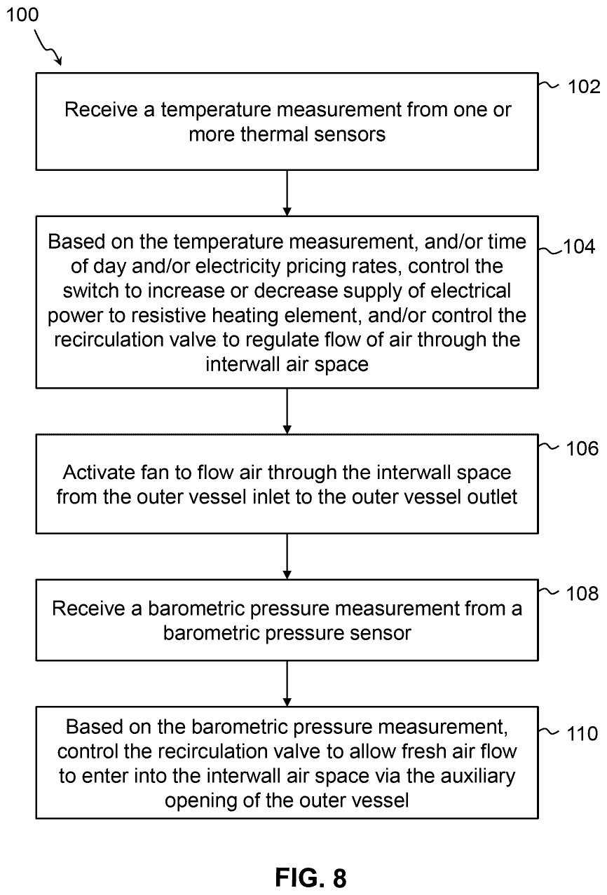

FIG. 8 is a flow chart of an embodiment of a method 100 of operating a thermal storage apparatus 10 of the present disclosure, which may be implemented by the controller 46 (as described above). It will be understood that the steps of the method 100 may be performed repeatedly and in real time. It will be understood that steps 108 and 110 may be performed concurrently or non-concurrently with steps 102 to 106.

At step 102, the controller 46 receives a temperature measurement from one or more thermal sensors 42.

At step 104, based on the temperature measurement, and/or other factors (e.g., a time of day, an electricity price rate), the controller 46 controls the switch 44 to increase or decrease supply of electrical power to the electric heater 40 to regulate the heating of the particulate heat storage material 38. The inner vessel wall conducts heat from the heated particulate heat storage material 38 to the interwall air space 24. The controller 46 may also control the recirculation valve 28 to regulate flow of air through the recirculation conduit 26 into the interwall air space 24.

At step 106, the fan 58 is operated to flow air through the interwall air space 24 from the outer vessel inlet 14 (which may be connected to a return air duct of a building) to the outer vessel outlet 16 (which may be connected to a supply air duct of a building). The fan 58 may be operated non-contemporaneously with supplying electrical energy to the electric heater 40. For example, electricity may be supplied to the electric heater 40 for a period during a day (e.g., early morning) when electricity rates are lowest, or when electrical demand at a home is lowest. The heat generated by the electric heater 40 is stored in the particulate heat storage material 38. While electricity is not being supplied to the electric heater 40, the fan 58 may be operated intermittently during the day to circulate unheated air from a return air duct through the interwall air space 24 to the supply air duct of the building to heat the building, as needed. The amount of stored heat that is dissipated from the particulate heat storage material 38 will depend on the amount of air that is flowed through the interwall air space 24.

At step 108, the controller 46 receives a barometric pressure measurement from the barometric pressure sensor 43. At step 110, based on the barometric pressure measurement, the controller 46 controls the recirculation valve 28 to allow fresh air from the auxiliary inlet 23 to flow into the interwall air space 24 via the auxiliary opening 17 of the outer vessel 12. For example, the measured barometric pressure may indicate the barometric pressure inside a part of the house. If the measured barometric pressure is below a predefined threshold pressure, then the recirculation valve 28 may close the recirculation conduit 26 to allow fresh air from the auxiliary inlet 32 to enter into the plenum 30 to increase the barometric pressure in the house.

Although preferred embodiments of the invention have been described herein in detail, it will be understood by those skilled in the art that variations may be made thereto without departing from the spirit of the invention or the scope of the appended claims.

### PARTS LIST

10 apparatus
12 outer vessel
14 outer vessel inlet
16 outer vessel outlet
17 outer vessel auxiliary opening
18 inlet conduit
20 outlet conduit
21 auxiliary conduit
23 auxiliary inlet
22 inner vessel
24 interwall air space
26 recirculation conduit
28 recirculation valve
30 plenum
34 baffle
36 baffle aperture
38 particulate heat storage material
40 electric heater
42 thermal sensor
43 barometric pressure sensor
44 switch
45 power source connection
46 controller
48 processor
50 memory
52 control method instructions
54 display device
56 user input device
57 connection for communication network
58 fan
60 filter
62 tube
100-110 method, and steps thereof

1. An apparatus comprising:
an outer vessel comprising an outer vessel wall that defines an outer vessel interior space, an outer vessel inlet, and an outer vessel outlet, wherein the outer vessel inlet and the outer vessel outlet are spaced apart from each other in a longitudinal direction;
an inner vessel extending in the longitudinal direction and comprising an inner vessel wall that defines an inner vessel interior space, wherein the inner vessel is disposed in the outer vessel interior space with the inner vessel wall spaced apart from the outer vessel wall in a lateral direction transverse to the longitudinal direction to define an annular interwall air space between the outer vessel wall and the inner vessel wall that surrounds the inner vessel wall and is in fluid communication with the outer vessel inlet and the outer vessel outlet;
a particulate heat storage material comprising sand and disposed in the inner vessel interior space and in contact with the inner vessel wall; and
an electric heater, wherein at least part of the electric heater is embedded in the particulate heat storage material.

2-10. (canceled)

11. The apparatus of claim 1, wherein the outer vessel inlet is oriented to direct, into the interwall air space, an air stream that is offset from a center of the outer vessel in a cross-sectional plane in the lateral direction.

12-13. (canceled)

14. The apparatus of claim 1, wherein:
the outer vessel outlet comprises a first outer vessel outlet and a second outer vessel outlet;
the first outer vessel outlet is oriented to direct, out of the interwall air space, a first air stream in the longitudinal direction; and
the second outer vessel outlet is oriented to direct, out of the interwall air space, a second air stream in the lateral direction.

15. The apparatus of claim 14, further comprising a recirculation conduit extending between the second outer vessel outlet and the outer vessel inlet to establish fluid communication from the second outer vessel outlet to the outer vessel inlet via the recirculation conduit.

16. (canceled)

17. The apparatus of claim 16, wherein:
the apparatus further comprises:
a recirculation valve positioned to regulate air flow through the recirculation conduit, wherein the recirculation valve is an electromechanically operated valve;
a thermal sensor positioned to measure a temperature; and
a controller comprising a processor and a memory comprising a non-transitory computer readable medium storing instructions executable by the processor to actuate the recirculation valve based on the temperature measured by the thermal sensor.

18. (canceled)

19. The apparatus of claim 1, wherein the outer vessel defines an auxiliary opening in fluid communication with the interwall air space to allow fresh air to enter the interwall air space and to mix with air in the interwall air space.

20. (canceled)

21. The apparatus of claim 1, wherein:
the apparatus further comprises:
a valve positioned to regulate air flow through the auxiliary opening, wherein the valve is an electromechanically operated valve;
a barometric pressure sensor positioned to measure a barometric pressure;
a controller comprising a processor and a memory comprising a non-transitory computer readable medium storing instructions executable by the processor to actuate the valve based on the barometric pressure measured by the barometric pressure sensor.

22. (canceled)

23. The apparatus of claim 1, further comprising at least one baffle disposed in the interwall air space, and attached to at least one of the outer vessel wall and the inner vessel wall, wherein the baffle defines a baffle aperture allowing fluid communication through the interwall air space from the outer vessel inlet to the outer vessel outlet.

24. (canceled)

25. The apparatus of claim 1, wherein the at least one baffle comprises a plurality of baffles that are spaced apart from each other in the longitudinal direction, and wherein the baffle aperture of a first one of the baffles and the baffle aperture of a second one of the baffles are spaced apart from each other in the lateral direction.

26. (canceled)

27. The apparatus of claim 1, wherein the particulate heat storage material consists of sand, and wherein the particulate heat storage material further comprises metallic particles mixed with the sand.

22-31. (canceled)

32. The apparatus of claim 1, further comprising:
a thermal sensor positioned to measure a temperature of a part of the apparatus, or of a location inside or outside of a building;
a switch operable to regulate supply of electrical power to the electric heater; and
a controller comprising a processor and a memory comprising a non-transitory computer readable medium storing instructions executable by the processor to control the switch based at least on at least one of the temperature measured by the thermal sensor, a time of day, and an electricity price.

33-35. (canceled)

36. The apparatus of claim 1, wherein the apparatus further comprises an electrically powered fan operable to create an air flow from the outer vessel inlet to the outer vessel outlet via the interwall air space.

37-38. (canceled)

39. The apparatus of claim 1, further comprising a tube extending from the outer vessel inlet, via the interwall air space, to the outer vessel outlet, to permit fluid communication from the outer vessel inlet to the outer vessel outlet via the tube.

40. (canceled)

41. The apparatus of claim 1, further comprising a tube extending through the outer vessel wall, the inner vessel wall and the particulate heat storage material.

42. A system for heating a building comprising a supply air duct terminating in a heat vent, the system comprising the apparatus of claim 1, wherein the outer vessel outlet is connected to the supply air duct to permit fluid communication from the interwall air space to the supply air duct via the outer vessel outlet.

43. The system of claim 42, wherein the building comprises a return air duct, and wherein the outer vessel inlet is connected to the return air duct to permit fluid communication from the return air duct to the interwall air space via the outer vessel inlet.

44. A method for heating a building, the method comprising:
supplying electrical energy to the electric heater of any apparatus of claim 1 to heat the particulate heat storage material;
allowing the inner vessel wall to conduct heat from the particulate heat storage to the interwall air space; and
operating a fan to flow air through the interwall air space from the outer vessel inlet to the outer vessel outlet.

45. The method of claim 44, wherein operating the fan is performed non-contemporaneously with supplying electrical energy to the electric heater.

46. The method of claim 44, wherein the outer vessel outlet is connected to a supply air duct of the building to permit fluid communication from the interwall air space the supply air duct via the outer vessel outlet.

47. The method of claim 44, wherein the outer vessel inlet is connected to a return air duct of the building to permit fluid communication from the return air duct to the interwall air space via the outer vessel inlet.
